(19) United States
(12) Patent Application Publication
(10) Pub. No.: US 2026/0237768 A1
(43) Pub. Date: Aug. 13, 2026

(54) Method for Determining Moisture in an Interior

(71) Applicant: Bayerische Motoren Werke Aktiengesellschaft, Muenchen (DE)

(72) Inventors: Patrick BERNING, Muenchen (DE); Jochen BRANDMAIER, Taufkirchen (DE); Johannes LUTZ, Utting am Ammersee (DE)

(21) Appl. No.: 19/470,861

(22) PCT Filed: Jun. 17, 2024
(86) PCT No.: PCT/EP2024/066827

§ 371 Date: Sep. 30, 2025

(30) Foreign Application Priority Data
Jul. 19, 2023 (DE) 10 2023 119 007.5

(51) Int. Cl. H01M 10/48; H01M 10/42

(52) U.S. Cl. CPC H01M 10/48; H01M 10/4228; H01M 10/425; H01M 2010/4271; H01M 2220/20

(57) ABSTRACT

A method for determining moisture, in particular water or water vapor, in an interior of a housing of an electrical energy storage device for a motor vehicle, said interior, depending on a closure state of a pressure compensation apparatus of the energy storage device, being in fluidic connection with an exterior being separated from the exterior, wherein, in particular on a model basis, an overall moisture parameter of the interior describing the moisture is determined based on a sum of entry parameters determined at different times and/or at different operating points, which entry parameters describe an entry of moisture into the interior at a particular time and/or at a particular operating point.

### BACKGROUND AND SUMMARY

This disclosure relates to a method for determining moisture, in particular water or water vapor, in an interior of a housing of an electrical energy storage device for a motor vehicle, which interior has a fluidic connection to an exterior or is separated from the exterior depending on a closure status of a pressure equalization unit of the energy storage device.

Energy storage devices for motor vehicles, for example, so-called “high-voltage storage devices”, which have a housing in which electrical energy storage cells of the electrical energy storage device are arranged, are fundamentally known from the prior art. A fluidic connection is typically established between the interior and the surroundings or the exterior of the housing in order to enable a pressure equalization between the interior and the surroundings. It is known in this case that pressure equalization units, such as membranes, valves, and the like can be used in order to establish or disconnect the fluidic connection depending on the closure status. In particular it is to be taken into consideration in such pressure equalization units that a fluidic connection, i.e. an air exchange can also cause an exchange or an introduction of moisture into the interior. For example, water can occur in gaseous form as water vapor or also in liquid form, for example, as a condensate, and thus penetrate into the interior of the housing.

An increased ambient humidity can impair the functionality of the electrical energy storage device, for example, cause corrosion effects on metallic components or electrical plug connections and also influence structural-mechanical properties of components by intercalating liquid or moisture.

To avoid such effects, approaches are known in order to reduce an introduction of moisture or deliberately remove moisture from the interior or bind it in the interior. For this purpose, materials that bind moisture, in particular granules, membranes, or completely closed housings are known, for example. In particular the formation of completely closed housings can only be implemented with a significant expenditure with respect to installation space, weight, and costs. Nonetheless, no information about the current moisture in the interior is present in the case of the reduction of the introduction of the moisture or the binding or removal of moisture from the interior, for example, whether a material binding moisture is already saturated, whether or when active drying is required or is sufficiently completed.

The disclosure is based on an object of specifying a method improved in relation thereto for determining moisture in an interior of a housing of an electrical energy storage device for a motor vehicle.

As described, the disclosure relates to a method for determining moisture, in particular water or water vapor, in an interior of a housing of an electrical energy storage device for a motor vehicle, which interior has a fluidic connection to an exterior or is separated from the exterior depending on a closure status of a pressure equalization unit of the energy storage device. In other words, using the method described herein, the moisture in the interior of the housing of the energy storage device is to be determined, so that a statement can be made about the moisture or the amount of water inside the housing. A solely qualitative statement or a quantified statement is possible in this case, so that, for example, a decision can be made as to whether a further measure is necessary, for example, maintenance or drying of the interior.

The disclosure is based on the finding that, in particular in a model-based manner, an overall moisture parameter of the interior, which describes the moisture, based on a sum of entry parameters determined at various times and/or in various operating points is determined, which entry parameters describe an entry of moisture at a specific time and/or in a specific operating point into the interior. The determined overall moisture parameter specifies how much moisture is currently accommodated in the interior. The overall moisture parameter can be managed, for example, as a unitless number in the form of a counter or it is possible that the overall moisture parameter can specify, for example, a percentage or a mass or a volume.

The overall moisture parameter is determined from the sum of the entry parameters which describe the entry of moisture into the housing for various times or operating points. In principle, the entry parameter can be positive, in particular if moisture enters the interior from the exterior. It is also possible that the entry parameter is negative, in particular if moisture is discharged from the interior to the exterior. The introduction of moisture from the exterior into the interior or vice versa is known to be determined on the basis of the environmental conditions, i.e. how much moisture is currently absorbed in the air in the exterior and the interior and how an adaptation of the relationships takes place when establishing the fluidic connection by opening the pressure equalization unit, in particular also in which direction air flows upon opening of the pressure equalization unit.

The entry parameter can be determined here for various times and/or operating points, in particular over the service life of the electrical energy store or the electrical energy storage device, so that it can be determined at each time how much moisture is absorbed, at least qualitatively, inside the interior. This in particular permits complex retrofitting in the sense of a hardware change to not be necessary for energy storage devices in the field, but rather that the method can be applied in order to ascertain how the moisture behaves in the interior, in particular how the overall moisture parameter changes further over the operation of the motor vehicle or the energy storage device. The determination of the overall moisture parameter can in particular take place in a model-based manner, i.e. various input parameters can be taken into consideration and the overall moisture parameter can be formed therefrom. In particular, the entry parameters can depend on various further environmental parameters or interior parameters which will be described hereinafter.

According to one embodiment of the method, it can be provided that at least one entry parameter is determined based on a difference in at least one environmental parameter, in particular the temperature and/or the ambient humidity and/or the air pressure, between the interior and the exterior. As described, the entries of the moisture into the interior result from the difference of the conditions inside the interior and in the exterior. If the ambient humidity in the exterior is higher than the interior, for example, upon opening of the pressure equalization unit, moisture is also conveyed into the interior due to the volume exchange, in particular in the event of positive pressure in the exterior. Likewise, if the moisture in the interior is higher than in the exterior, a resulting entry parameter can be negative, so that moisture can be discharged into the exterior, in particular in the case of negative pressure in the exterior. Furthermore, the entry parameters can depend on the temperature and air pressure. The air pressure determines in particular here whether the pressure equalization unit is open and or to what degree it is open, so that a “passive determination” of opening of the pressure equalization unit is possible even if it is not opened by outputting a switching signal like an actuatable valve, for example. Furthermore the pressure relationships determine the flow direction of the air into the interior or out of the interior. The conditions in the interior and in the exterior can especially be modeled, so that the entry parameters can be determined in a model-based manner upon opening of the pressure equalization unit or by diffusion and leakage over all times or operating points, from which the overall moisture parameter results, in particular by summation.

The described method can furthermore be refined in that the at least one environmental parameter is determined indirectly, in particular based on navigation data and/or weather data, or directly, in particular based on data from an environmental sensor. For example, it is possible to ascertain heights or height differences in operation of the motor vehicle based on navigation data. When driving through a route profile that has corresponding height differences, it can be established here whether this causes the pressure equalization unit to open so that an air exchange is possible. Furthermore, entry parameters can be determined by leakage or diffusion from the pressure differences building thereon. The environmental parameter can furthermore be determined by weather data, for example, retrieved from a weather database. The weather data can in particular comprise the temperature, the ambient humidity, the precipitation, the air pressure, and the like. It is likewise possible to determine the at least one environmental parameter directly, for example, by way of a pressure sensor, temperature sensor, precipitation sensor, moisture sensor, and the like.

Furthermore, it can be provided in the method that at least one entry parameter is determined directly or indirectly based on the closure status of the pressure equalization unit. As described, the closure status of the pressure equalization unit determines the main component for the fluidic connection between the interior and the exterior. In addition to the pressure equalization unit, a leakage or a diffusion is possible, which results as significantly smaller in relation to the volume flow through the open pressure equalization unit. The entry parameter can therefore be determined by determining the closure status of the pressure equalization unit. In particular in combination with the at least one environmental parameter, it can therefore be determined how the moisture changes in the interior, which can be output as the overall moisture parameter.

As described, the pressure equalization unit can in principle represent a passive element, in particular a spring-operated valve. It is likewise possible that the pressure equalization unit has at least one switchable valve. In the first case, for example, in the event of ascertained pressure differences, opening of the pressure equalization unit can be determined, for example, when a specific differential pressure is reached, so that the spring-operated valve opens. In the second described case, the switching signals that are supplied to the pressure equalization unit can be analyzed. Ultimately, it is therefore possible to count how often or how long the pressure equalization unit was opened in order to thus be able to determine the moisture entry.

It is especially possible that at least one entry parameter is determined depending on an opening status, in particular an opening procedure and/or an opening duration, of the pressure equalization unit and/or at least one entry parameter is determined depending on a duration within a specific environment. Various entry parameters can especially be combined with one another, for example, an entry parameter which describes an entry of moisture due to opening of the pressure equalization unit, with an entry parameter which describes the stay of the electrical energy storage device in a specific environment. Leaks and diffusion-related effects can also be incorporated in particular in this way.

The overall moisture parameter can, according to a further design of the method, comprise a first counter describing opening statuses of the pressure equalization unit in a first environment and a second counter describing opening statuses of the pressure equalization unit in a second environment. It can thus be distinguished on the basis of various counters how long or how often the pressure equalization unit was open or had been opened in which environment or which type of environment. The environments can differ on the basis of their environmental parameters. For example, the first environment can represent a comparatively dry and/or comparatively cool environment. In contrast, the second environment can represent a moister and/or warmer environment.

The effect of the opening statuses can thus be classified with respect to the entries of moisture into the interior thus implemented. If the pressure equalization unit is opened, for example, in the first environment, i.e. in comparatively dry and warm environmental conditions, this results in a comparatively minor entry of moisture or even a negative entry, i.e. a discharge of moisture, so that moisture can be discharged into the environment. In contrast, if the pressure equalization unit is opened in the second environment, cold and/or moist air can penetrate into the interior and thus increase the entry of moisture. The distinction between the at least one first environment and the at least one second environment can be performed, for example, on the basis of weather data, GPS data, environmental conditions, and the like.

As described, the overall moisture parameter is preferably managed over the lifetime of the motor vehicle or the electrical energy storage device. The overall moisture parameter is therefore in particular stored in a permanent memory, for example, an EEPROM. The overall moisture parameter is therefore not deleted or “forgotten” even in idle statuses of the motor vehicle. Instead, the overall moisture parameter is permanently stored and read out again if necessary when the motor vehicle is started. The use of the described counter in particular permits the evaluation of GPS data, wherein only the counter is stored, however. The described counters are thus separated from personalized data or it is not necessary to store GPS data, for example, about a traveled route.

According to a further embodiment of the method, it can be provided that at least one entry parameter describes, in particular by way of a constant entry term, an entry of moisture due to leakage and/or due to diffusion. As described, the entries caused by leakage and/or by diffusion result in a significantly smaller proportion in the change of the moisture in the interior in comparison to opening the pressure equalization unit. These can be described, for example, by constant entry terms which can possibly be selected differently depending on the environment. It is likewise possible that the entry parameter describing the entry of moisture due to leakage and/or due to diffusion is changeable by environmental parameters, i.e. represents a function of the environmental parameters. In particular, this can be supported, as already described, on weather data, sensor data, and the like. Furthermore, influences of the environment on the interior of the electrical energy storage device can be incorporated, for example, when the motor vehicle is not operated, but act on the housing of the electrical energy storage device via the change between day and night, or the stay in a climate-controlled garage and the movement into the environment.

As already described, it can be fundamental that the pressure equalization unit can be deliberately controlled, for example, the closure status of the pressure equalization unit can be deliberately set. According to one embodiment of the method, it can be provided that the pressure equalization unit is opened depending on the overall moisture parameter and/or a current entry parameter. For example, this can be executed by outputting a switching signal to the pressure equalization unit, so that the pressure equalization unit, for example, a controllable valve, opens. If the overall moisture parameter, in particular in comparison to the current environmental conditions, has the result that the moisture in the interior is above that in the exterior, moisture can be deliberately discharged from the interior into the exterior by deliberate opening of the pressure equalization unit, in particular in the event of a positive pressure in the interior. This is the case in particular if a negative entry, i.e. a discharge of moisture, is determined for the current entry parameter. The delivery of the moisture can in turn be recorded in the overall moisture parameter and this can be “updated” due to the deliberate discharge of moisture.

In the method, it can furthermore be provided that the overall moisture parameter is output and/or a maintenance measure is carried out depending on the overall moisture parameter. For example, the overall moisture parameter can be output by way of a display unit of the motor vehicle or a user. Furthermore, a maintenance measure can be carried out depending on the overall moisture parameter, for example, the user of the motor vehicle is called upon to find a repair shop or the overall moisture parameter is read out during a service measure. It is especially possible to specify the amount of water in the interior on the basis of the overall moisture parameter and to decide based thereon which maintenance measure is to be carried out, for example, drying.

In addition to the method, the disclosure relates to a determination device for determining moisture, in particular water or water vapor, in an interior of a housing of an electrical energy storage device for a motor vehicle, which interior has a fluidic connection to an exterior or is separated from the exterior depending on a closure status of a pressure equalization unit of the energy storage device, wherein the determination device is designed to determine, in particular in a model-based manner, an overall moisture parameter of the interior describing the moisture based on a sum of entry parameters determined at various times and/or in various operating points, which entry parameters describe an entry of moisture at a specific time and/or in a specific operating point into the interior.

Furthermore, the disclosure relates to a motor vehicle, comprising an electrical energy storage device and an above-described determination device. The determination device is designed in particular to carry out the above-described method in all details.

All advantages, details, embodiments, and/or features which were described with reference to the method are completely transferable to the determination device and the motor vehicle.

### BRIEF DESCRIPTION OF THE DRAWINGS

FIG. 1 shows a schematic representation of a motor vehicle, comprising an electrical energy storage device and a determination device according to an exemplary embodiment; and,

FIG. 2 shows a schematic representation of a flow chart of the method according to an exemplary embodiment.

### DETAILED DESCRIPTION OF THE DRAWINGS

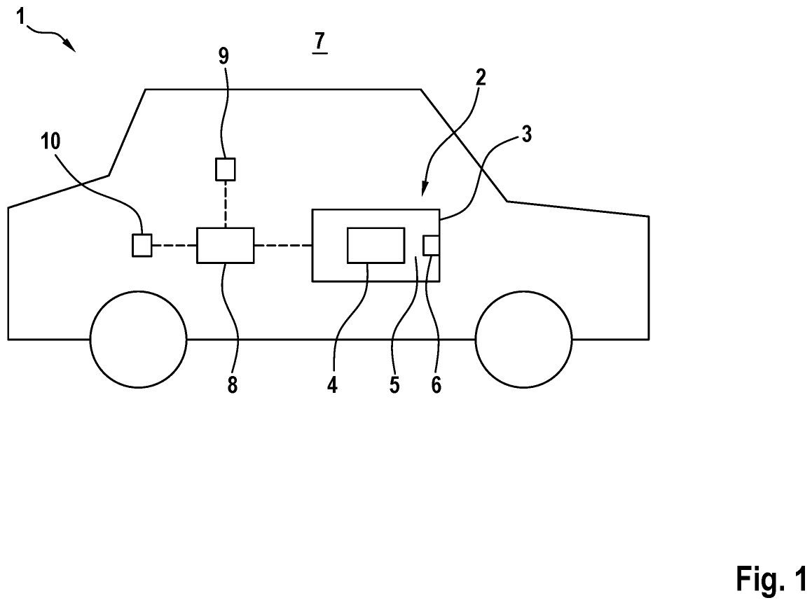

FIG. 1 shows a motor vehicle 1, comprising an electrical energy storage device 2 (e.g., a battery) having a housing 3 and at least one energy storage cell 4, which is arranged in the housing 3. The housing 3 has an interior 5, which has a fluidic connection if needed or the fluidic connection can be established if needed via a pressure equalization unit 6 to an exterior 7, for example, an environment of the motor vehicle 1. In a closed status of the pressure equalization unit 6, no fluidic connection exists or the fluidic connection is disconnected. In an opening status of the pressure equalization unit 6, the fluidic connection is established in that the pressure equalization unit 6, for example, a spring-operated valve, is open.

The motor vehicle 1 furthermore has a determination device 8 (e.g., a controller or processor for executing software, instructions, or logic stored in a memory), which is designed to carry out a method for determining moisture in the interior 5 of the housing 3. The determination device 8 can especially determine an overall moisture parameter of the interior 5, which describes which moisture is accommodated in the interior 5, for example, as condensed water or as water vapor.

The determination device 8 can be connected to an external source 9, for example, a navigation unit, which can provide the GPS data of the motor vehicle 1 and/or to a weather database, which specifies the current weather in the environment or in the exterior 7 of the motor vehicle 1. Furthermore, the determination device 8 can be coupled with at least one environmental sensor 10, which can have, for example, a temperature sensor and/or a pressure sensor and/or a moisture sensor. The external source 9 and the environmental sensor 10 are solely optional.

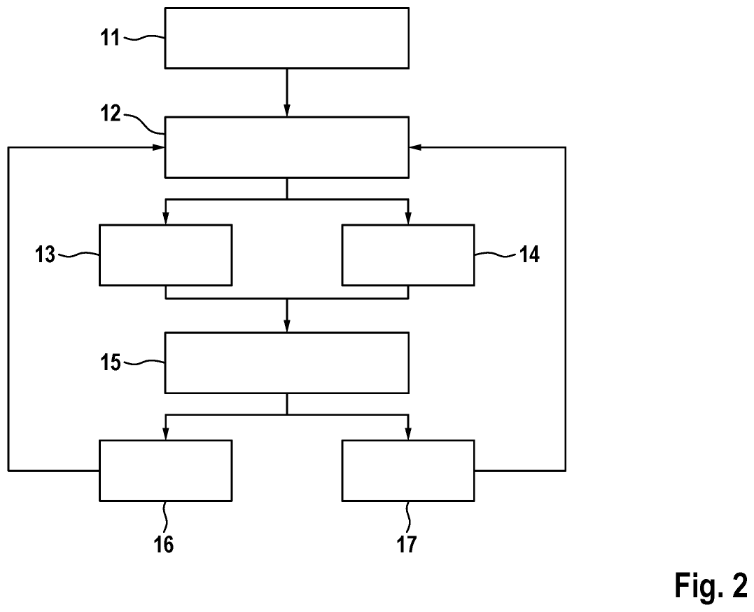

The method carried out by the determination device 8 will be explained hereinafter on the basis of the schematic flow chart in FIG. 2. The method can start in a block 11, in which the current overall moisture parameter, i.e. the overall moisture parameter determined up to the current lifetime, can be read out from a permanent memory, for example, an EEPROM. The overall moisture parameter can therefore advantageously be permanently stored and continued over the entire lifetime of the energy storage device 2, so that it is not lost during an idle status or parking of the motor vehicle 1. Upon parking of the motor vehicle 1, the overall moisture parameter continued further up to this point can be stored in the permanent memory again.

The method can be continued in a block 12, in which entry parameters for the current time or for the current operating point are determined. The entry parameters describe the current entry of moisture into the interior 5 or out of the interior 5 into the exterior 7. In principle, the entry parameters can therefore be positive or negative and therefore increase or decrease the overall moisture parameter. In principle, it is possible to branch from block 12 to block 13 or block 14. In block 13, an entry parameter is determined which describes the entry of moisture due to opening of the pressure equalization unit 6. This can be ascertained, for example, indirectly or passively by a determined pressure difference between the interior 5 and the exterior 7. The pressure difference can in turn be determined indirectly by a height difference of a route profile of the motor vehicle 1, for example, from the external source 9, in particular the height data, which can be part of the GPS data.

In block 14, an entry parameter can be determined which can describe the entry of moisture caused by leakage and/or diffusion. In this case, these can be constant terms in the case of which, for example, knowing the environment, the moisture in the interior 5 is influenced consistently or approximately consistently, since, for example, during operation in a comparatively warm and moist environment, a constant entry of moisture takes place. Both the entry parameter in block 13 and the entry parameter in block 14 can be embodied as functions of environmental parameters, so that a determination of the overall moisture parameter in a model-based manner is possible. For example, data of the at least one environmental sensor 10 can be used. Weather data can likewise be used. In principle, the entry parameters can therefore be specified depending on the current boundary conditions in the interior 5 and in the exterior 7. Moisture differences between the air in the interior 5 and in the exterior 7 can especially be determined in this case and the entry parameters can thus be defined.

The overall moisture parameter can then be updated based on the current entry parameters, for example, for the number of the opening statuses, the duration of the opening statuses, the duration of the operation in the specific environment, and the like. The overall moisture parameter can in particular be updated and continued in block 15. The overall moisture parameter can have a first counter and a second counter here. Depending on the current environmental conditions, the overall moisture parameter from block 15 can therefore change a first counter in a block 16 or a second counter in a block 17. The first counter can in principle, for example, map the number of the opening statuses of the pressure equalization unit 6 in environments not critical for an entry of moisture and the second counter can map the number of the opening statuses and/or the duration of the opening statuses for critical environments.

For example, the environments can be distinguished from one another as first environments and second environments. Comparatively dry and/or cool environments can be understood as first environments. Therefore, a relative ambient humidity and/or a temperature can be used as a distinction criterion. The second environments are warmer and/or moister environments in relation thereto. The first counter can therefore in principle relate to the number of the opening statuses and/or the duration of the opening statuses of the pressure equalization unit 6. The second counter can be used for the critical entries of moisture, for example, it can thus be determined how much moisture has collected in the interior 5.

Based on the overall moisture parameter, for example, in block 15, at least one measure can be taken. An output of the overall moisture parameter, i.e. a message about the current moisture status of the interior 5, can especially be output. A measure can thus be taken, for example, a service measure, a maintenance, a drying, and the like.

The advantages, details, and features described in the individual exemplary embodiments are combinable with one another, exchangeable among one another, and transferable to one another as desired. The motor vehicle 1, in particular the determination device 8, is completely designed to carry out the method described in FIG. 2.

### LIST OF REFERENCE SIGNS

1 motor vehicle
2 energy storage device
3 housing
4 energy storage cell
5 interior
6 pressure equalization unit
7 exterior
8 determination device
9 external source
10 environmental sensor
11-17 block

1.-11. (canceled)

12. A method for determining moisture in an interior of a housing of an electrical energy storage device for a motor vehicle, which interior is fluidically connected to an exterior or is separated from the exterior depending on a closure status of a pressure equalization unit of the energy storage device, wherein an overall moisture parameter of the interior, which describes the moisture, is determined in a model-based manner, based on a sum of entry parameters determined at various times and/or in various operating points, which entry parameters describe an entry of moisture at a specific time and/or in a specific operating point into the interior.

13. The method according to claim 12, wherein at least one entry parameter is determined based on a difference in at least one environmental parameter, comprising the temperature and/or the ambient humidity and/or the air pressure, between the interior and the exterior.

14. The method according to claim 13, wherein the at least one environmental parameter is determined indirectly, based on navigation data and/or weather data, or directly, based on at least one environmental sensor.

15. The method according to claim 12, wherein at least one entry parameter is determined directly or indirectly based on the closure status of the pressure equalization unit.

16. The method according to claim 12, wherein at least one entry parameter is determined depending on an opening status, comprising an opening procedure and/or an opening duration, of the pressure equalization unit and/or at least one entry parameter is determined depending on a duration within a specific environment.

17. The method according to claim 12, wherein the overall moisture parameter comprises a first counter describing opening statuses of the pressure equalization unit in a first environment and a second counter describing opening statuses of the pressure equalization unit in a second environment.

18. The method according to claim 12, wherein at least one entry parameter describes, by way of a constant entry term, an entry of moisture due to leakage and/or due to diffusion.

19. The method according to claim 12, wherein the pressure equalization unit is open depending on the overall moisture parameter and/or a current entry parameter.

20. The method according to claim 12, wherein the overall moisture parameter is output and/or a maintenance measure is carried out depending on the overall moisture parameter.

21. A determination device for determining moisture in an interior of a housing of an electrical energy storage device for a motor vehicle, which interior is fluidically connected to an exterior or is separated from the exterior depending on a closure status of a pressure equalization unit of the energy storage device, wherein the determination device is configured to determine an overall moisture parameter of the interior, which describes the moisture in a model-based manner, based on a sum of entry parameters determined at various times and/or in various operating points, which entry parameters describe an entry of moisture at a specific time and/or in a specific operating point into the interior.

22. A motor vehicle, comprising an electrical energy storage device and a determination device according to claim 21.
